(19) United States
(12) Patent Application Publication
(10) Pub. No.: US 2013/0212458 A1
(43) Pub. Date: Aug. 15, 2013

(54) DISPLAY CONTROL DEVICE, DISPLAY CONTROL METHOD, AND DISPLAY CONTROL PROGRAM

(71) Applicants: Asami OKADA, Tokyo (JP); Takehiko ISHIZUKA, Tokyo (JP)

(72) Inventors: Asami OKADA, Tokyo (JP); Takehiko ISHIZUKA, Tokyo (JP)

(21) Appl. No.: 13/712,535

(22) Filed: Dec. 12, 2012

(30) Foreign Application Priority Data
Feb. 13, 2012 (JP) 2012-028247

(51) Int. Cl. G06F 17/24

(52) U.S. Cl. CPC G06F 17/246
USPC 715/217

(57) ABSTRACT

Disclosed is a display control device including a selection information acquiring part 2 for acquiring a program ID showing a program currently being selected from among a plurality of cells which construct an electronic program guide, a cell searching part 3 for referring to attribution information stored in a cell attribute information storage unit 1 to search through the plurality of programs for programs each having the same attribute as the program currently being selected, and a reallocation processing part 4 for deleting the cells other than the cell currently being selected and one or more cells found by the cell searching part 3 from the plurality of cells, and for shifting the cell currently being selected and the one or more cells found by the cell searching part 3 forward in a vertical direction or in a horizontal direction to display these cells.

### BACKGROUND OF THE INVENTION

1. Field of the Invention

The present invention relates to a display control device for, a display control method of, and display control program for displaying, for example, a TV electronic program guide, a schedule table, or the like.

2. Description of Related Art

As display control devices which display an electronic program guide, for example, there are pieces of AV equipment, such as televisions and Blu-ray Disc recorders. In these display control devices, a plurality of cells which construct an electronic program guide correspond to individual programs, respectively, and a thumbnail image associated with a program, a title (program name), a character string showing the content of the program, etc. are displayed in each of the cells. In recent years, the amount of information to be displayed including images and character strings has been increasing with an improvement in the processing capabilities of display control devices, and enlargement of a display area (upsizing of displays).

While the increase in the amount of information to be displayed assists the user's selection of his or her desired program because a larger amount of information about programs is provided for the user, the program guide becomes complicated and it may take a longer time for the user to find his or her desired program. To solve this problem, an improvement in the ability to search for programs is required of display control devices.

To this end, a display control device having a function of “searching by genre” or “searching by keyword” has been developed as a means for searching through a TV electronic program guide for a desired program. This display control device enables the user to select either “searching by genre” or “searching by keyword”, and, when the user performs an operation of setting a “genre” or a “keyword”, searches for programs belonging to the genre set by the user, or programs associated with the keyword set by the user, and displays a list showing the results of search for programs (switches the display screen from the electronic program guide to a display of the list of the search results). As a result, while the user is enabled to grasp the programs matching the genre or the keyword, the list of the search results including information showing the channel of each of the programs matching the search criteria and information showing the program length (broadcast time) of each of the programs matching the search criteria is expressed by only characters. Therefore, it is difficult for the user to intuitively grasp the information showing the channel of each of the programs matching the search criteria, and it is also difficult for the user to intuitively grasp whether the program length (broadcast time) of each of the programs matching the search criteria is 30 minutes or 1 hour, for example.

Furthermore, the following patent reference 1 discloses a display control device which, when the user pushes down a “search for similar content” button, searches for a content (program) similar to a content (program) currently being selected, and places the similar content around the content currently being selected. As a result, while the user is enabled to grasp a content similar to the content currently being selected, there is a case in which it is difficult for the user to immediately understand the information which is displayed on the screen after a search for a similar content has been made because the screen layout varies a lot between before and after the search has been made.

### RELATED ART DOCUMENT

### Patent reference

Patent reference 1: Japanese Unexamined Patent Application Publication No. 2011-013860 (paragraph number [0036])

Because conventional display control devices are constructed as above, a problem with the conventional display control devices is that while they can search for some programs from among many programs, it is difficult for the user to intuitively grasp the channel, the program length, and so on of each program which has been found.

### SUMMARY OF THE INVENTION

The present invention is made in order to solve the above-mentioned problem, and it is therefore an object of the present invention to provide a display control device for, a display control method of, and a display control program for enabling the user to intuitively grasp information about each cell which has been found.

In accordance with the present invention, there is provided a display control device including: a cell attribute information storage unit for storing attribution information about a plurality of cells which construct a table to be drawn; a selection information acquiring unit for acquiring selection information showing a cell currently being selected from among the plurality of cells; a cell searching unit for referring to the attribution information stored in the cell attribute information storage unit to search through the plurality of cells for cells each having the same attribute as the cell currently being selected shown by the selection information acquired by the selection information acquiring unit; and a cell display unit for deleting cells other than the cell currently being selected shown by the selection information acquired by the selection information acquiring unit and one or more cells found by the cell searching unit from the plurality of cells, and for shifting the cell currently being selected and the one or more cells found by the cell searching unit forward in a vertical direction or in a horizontal direction to display these cells.

Because the display control device according to the present invention includes: the cell attribute information storage unit for storing attribution information about a plurality of cells which construct a table to be drawn; the selection information acquiring unit for acquiring selection information showing a cell currently being selected from among the plurality of cells; the cell searching unit for referring to the attribution information stored in the cell attribute information storage unit to search through the plurality of cells for cells each having the same attribute as the cell currently being selected shown by the selection information acquired by the selection information acquiring unit; and the cell display unit for deleting cells other than the cell currently being selected shown by the selection information acquired by the selection information acquiring unit and one or more cells found by the cell searching unit from the plurality of cells, and for shifting the cell currently being selected and the one or more cells found by the cell searching unit forward in a vertical direction or in a horizontal direction to display these cells, there is provided an advantage of enabling the user to intuitively grasp information about each cell which has been found.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a display control device according to Embodiment 1 of the present invention;

FIG. 2 is a flow chart showing processing (display control method) carried out by the display control device according to Embodiment 1 of the present invention;

FIG. 3 is an explanatory drawing showing an example of the grouping of programs by genre;

FIG. 4 is an explanatory drawing showing an example of a display of an electronic program guide;

FIG. 5 is a block diagram showing a display control device according to Embodiment 2 of the present invention;

FIG. 6 is a flow chart showing processing (display control method) carried out by the display control device according to Embodiment 2 of the present invention;

FIG. 7 is an explanatory drawing showing candidates for a search method of searching for programs;

FIG. 8 is an explanatory drawing showing an example of a display of a list of recorded programs; and

FIG. 9 is an explanatory drawing showing an example in which a plurality of programs which construct an electronic program guide are arranged and displayed on a surface of a cylindrical object.

### DETAILED DESCRIPTION OF THE PREFERRED EMBODIMENTS

### Embodiment 1

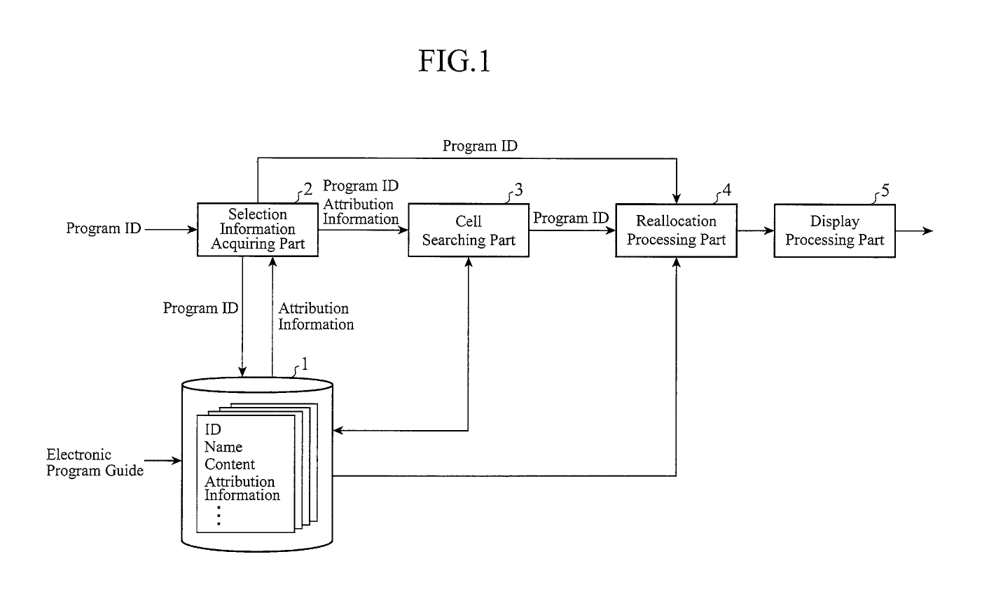

FIG. 1 is a block diagram showing a display control device according to Embodiment 1 of the present invention. The display control device shown in FIG. 1 displays a TV electronic program guide, a schedule table, or the like. In this Embodiment 1, an example in which a table to be drawn is an electronic program guide will be explained. The table to be drawn is limited to neither an electronic program guide nor a schedule table, and one of various tables can be applied as the table to be drawn.

In FIG. 1, a cell information storage part 1 consists of, for example, a recording unit, such as a RAM or a hard disk. The cell information storage part 1 collects a TV electronic program guide (a table to be drawn) which is received by, for example, AV equipment, such as a television, and stores cell information which is information about a plurality of programs (cells) which construct the electronic program guide therein. This cell information includes a program ID for identifying each program, the name of each program (program title), the content of each program (detailed information about each program), and attribution information showing the genre of each program and so on. The cell information storage part 1 constructs a cell attribute information storage unit.

A selection information acquiring part 2 consists of interface equipment (e.g., an infrared ray interface circuit or a LAN interface circuit) for acquiring information from, for example, a remote control, the AV equipment, or the like, a semiconductor integrated circuit in which a CPU is mounted, and so on. The selection information acquiring part 2 carries out a process of acquiring a program ID (selection information) showing a program currently being selected from among the plurality of programs which construct the electronic program guide from the remote control, the AV equipment, or the like. The selection information acquiring part 2 also carries out a process of acquiring the attribution information of the program having the program ID from the cell information storage part 1, and outputting the attribution information to a cell searching part 3. The selection information acquiring part 2 constructs a selection information acquiring unit.

The cell searching part 3 consists of, for example, an integrated circuit in which a CPU is mounted, or a one chip microcomputer, and carries out a process of comparing the attribution information outputted thereto from the selection information acquiring part 2 with the attribution information included in the cell information stored in the cell information storage part 1, and searching through the plurality of programs which construct the electronic program guide for programs each having the same attribute as the program currently being selected. The cell searching part 3 also carries out a process of, when finding a program having the same attribute as the program currently being selected, outputting a program ID showing the program currently being selected, and a program ID showing the program having the same attribute as the program currently being selected to a reallocation processing part 4. The cell searching part 3 constructs a cell searching unit.

The reallocation processing part 4 consists of, for example, an integrated circuit in which a CPU is mounted, or a one chip microcomputer, and carries out a process of outputting a display command for displaying the electronic program guide to a display processing part 5. The reallocation processing part 4 also carries out a process of, when receiving the program ID showing the program currently being selected, and the program ID showing the program having the same attribute as the program currently being selected from the cell searching part 3, outputting a command for clearing the display of the programs other than the programs shown by those program IDs in a state in which the electronic program guide is displayed to the display processing part 5, and, after that, outputting a command for removing the spaces caused by the clearing of the display to shift the programs shown by those program IDs forward in a vertical direction and display them to the display processing part 5. The display processing part 5 consists of, for example, a GPU (Graphics Processing Unit), and carries out a process of displaying the TV electronic program guide on a not-shown display according to a command from the reallocation processing part 4. A cell display unit is comprised of the reallocation processing part 4 and the display processing part 5.

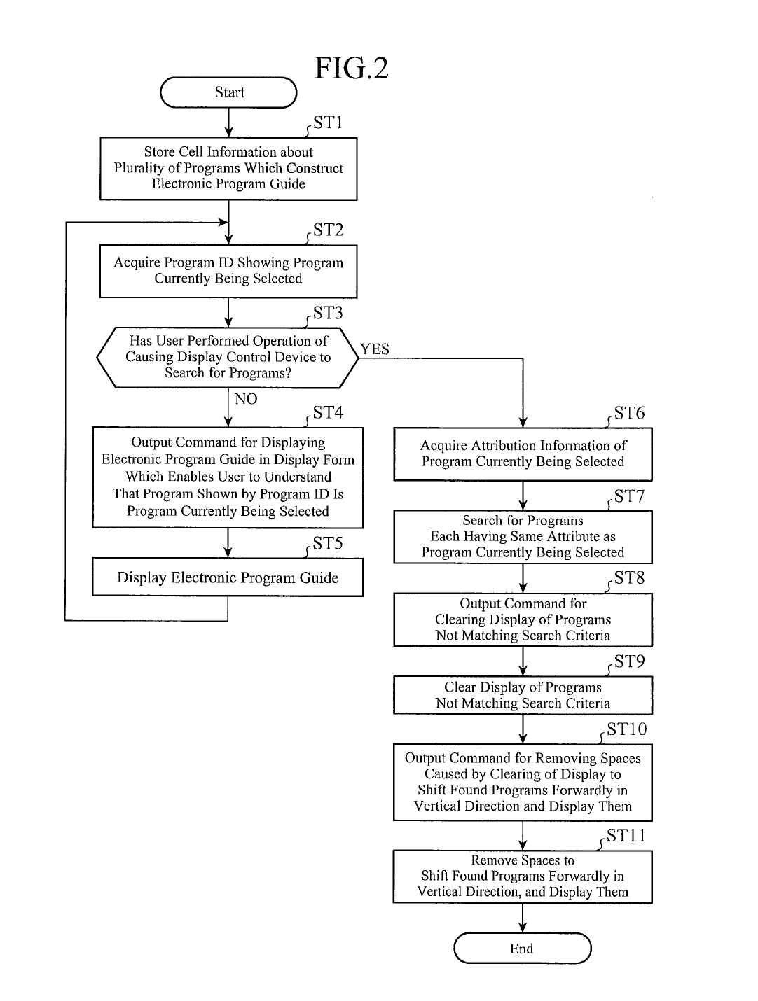

Although it is assumed in the example of FIG. 1 that the cell information storage part 1, the selection information acquiring part 2, the cell searching part 3, the reallocation processing part 4, and the display processing part 5, which are the components of the display control device, consist of pieces of hardware for exclusive use, respectively, the display control device can consist of a computer. In the case in which the display control device consists of a computer, the cell information storage part 1 can be formed in a memory of the computer while a display control program in which the processes carried out by the selection information acquiring part 2, the cell searching part 3, the reallocation processing part 4, and the display processing part 5 are described can be stored in the memory of the computer, a CPU of the computer can be made to execute the display control program stored in the memory, for example. FIG. 2 is a flowchart showing processing (display control method) carried out by the display control device according to Embodiment 1 of the present invention.

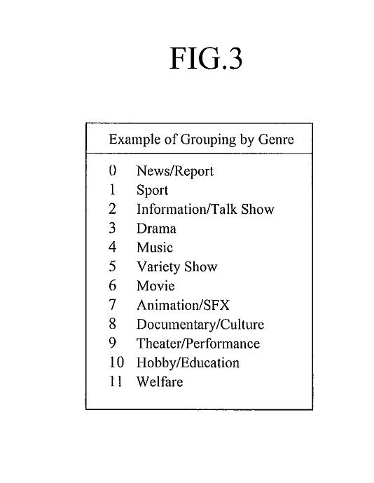

Next, the operation of the display control device will be explained. First, a TV electronic program guide received by the AV equipment, such as a television, is sent to the cell information storage part 1, and the cell information which is information about a plurality of programs which construct the electronic program guide is stored in the cell information storage part 1 (step ST1 of FIG. 2). At this time, this cell information includes a program ID for identifying each of the programs, the name of each of the programs (program title), the content of each of the programs, and attribution information showing the genre of each of the programs and so on. Programs are grouped into genres as shown in, for example, FIG. 3. In the example of FIG. 3, the genres into which programs are grouped include news/report, sport, information/talk show, and drama. As identification information showing each genre, “0” is assigned to news/report, “1” is assigned to sport, “2” is assigned to information/talk show, “3” is assigned to drama, and so on.

The selection information acquiring part 2 acquires a program ID showing a program currently being selected from among the plurality of programs which construct the electronic program guide from, for example, the remote control, the AV equipment, or the like (step ST2). When the user has not performed an operation of causing the display control device to search for programs (e.g. an operation of specifying the user's desired genre to command the display control device to search for programs belonging to the genre) (step ST3), the selection information acquiring part 2 outputs the program ID to the reallocation processing part 4. When the user has not performed an operation of causing the display control device to search for programs, in response to the program ID from the selection information acquiring part 2, the reallocation processing part 4 acquires the electronic program guide from the cell information storage part 1, and outputs a command for displaying the electronic program guide in a display form which enables the user to understand that the program shown by the program ID is the program currently being selected to the display processing part 5 (step ST4).

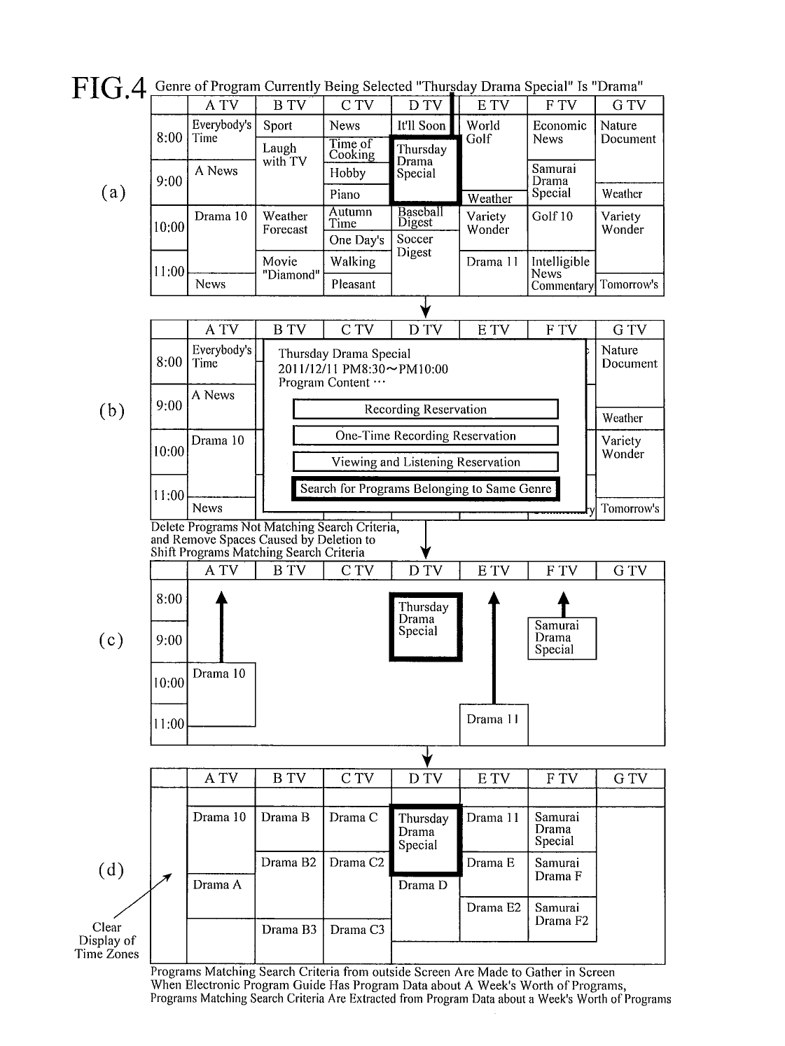

When receiving the command for displaying the electronic program guide from the reallocation processing part 4, the display processing part 5 displays the electronic program guide on the not-shown display (step ST5). FIG. 4 is an explanatory drawing showing an example of the display of the electronic program guide. FIG. 4(a) shows the electronic program guide in a display form in which the program currently being selected is “Thursday drama special.” Although the program currently being selected is enclosed by a thick box in the example of FIG. 4 (a), the program currently being selected can be alternatively displayed in, for example, a color different from that in which the other programs are displayed.

When the user performs an operation of causing the display control device to search for programs (step ST3), the selection information acquiring part 2 acquires the attribution information of a program having the program ID showing the program currently being selected from the cell information storage part 1, and outputs the attribution information of the program currently being selected and the above-mentioned program ID to the cell searching part 3 (step ST6). In FIG. 4 (b), an example in which the user performs an operation of pushing down a button of “Search for programs belonging to the same genre” as the operation of causing the display control device to search for programs is shown.

When receiving the attribution information and the program ID from the selection information acquiring part 2, the cell searching part 3 compares the attribution information with the attribution information included in the cell information stored in the cell information storage part 1, and searches through the plurality of programs which construct the electronic program guide for programs each having the same attribute as the program currently being selected (step ST7). For example, when the user has performed an operation of pushing down the button “Search for programs belonging to the same genre” as the operation of causing the display control device to search for programs, the cell searching part searches through the plurality of programs which construct the electronic program guide for programs whose genre is drama (identification information=3) when the genre shown by the attribution information of the program currently being selected shows is drama (identification information=3). When finding a program having the same attribute as the program currently being selected, the cell searching part 3 outputs the program ID showing the program currently being selected, and the program ID showing the program having the same attribute as the program currently being selected to the reallocation processing part 4. However, when there exists no program having the same attribute as the program currently being selected, the cell searching part 3 outputs only the program ID showing the program currently being selected to the reallocation processing part 4.

When receiving the program IDs (the program ID showing the program currently being selected and the program ID showing the program having the same attribute as the program currently being selected) from the cell searching part 3, the reallocation processing part 4 outputs a command for clearing the display of the programs other than the programs shown by those program IDs (the programs whose genres are other than drama when searching for programs whose genre is drama) to the display processing part 5 (step ST8). When receiving the command for clearing the display of the programs other than the programs shown by those program IDs from the reallocation processing part 4, the display processing part 5 clears the display of the programs other than the program shown by those program IDs (step ST9). For example, when searching for programs whose genre is drama, the display processing part clears the display of the programs other than the programs whose genre is drama, as shown in the FIG. 4(c).

When the display processing part 5 clears the display of the programs other than the programs shown by those program IDs, the reallocation processing part 4 outputs a command for removing the spaces caused by the clearing of the display to shift the programs shown by those program IDs forward in a vertical direction and display them to the display processing part 5 (step ST10). When receiving the command for removing the spaces caused by the clearing of the display to shift the programs shown by those program IDs forward in a vertical direction and display them from the reallocation processing part 4, the display processing part 5 removes the spaces to shift the programs shown by those program IDs forward in the vertical direction and display them, as shown in FIG. 4(d) (step ST11). At this time, a switch to each of the programs shown by those program IDs is carried out seamlessly by using an animation.

When the display processing part 5 removes the spaces to shift the programs forward in the vertical direction (in an upward direction) and display them, programs existing out of the displayed screen (programs existing below the displayed screen in the example of FIG. 4(d)) are also made to move to within and gather in the screen. As a result, when, for example, the electronic program guide has program data about a week's worth of programs, programs matching the search criteria are found from the program data about a week's worth of programs, and are made to move to within and gather in the screen. However, when many programs are found, there are some programs that are not moved to within the screen. Because the display processing part removes the spaces to shift the programs shown by the program IDs forward in the vertical direction (in an upward direction) and display them, the display processing part has cleared the display of information showing the broadcast time zone of each of the programs from the screen.

In the above-mentioned example of the electronic program guide, because programs in the same broadcast time zone provided by different broadcast stations are aligned in a horizontal direction while programs provided by each broadcast station are aligned in a vertical direction in the order of broadcast time zones, the display processing part removes the spaces to shift the programs shown by the program IDs forward in the vertical direction (in an upward direction) and display them. In contrast, in a case in which programs in the same broadcast time zone provided by broadcast different stations are aligned in a vertical direction in the electronic program guide while programs provided by each broadcast station are aligned in a horizontal direction in the order of broadcast time zones, the display processing part can remove the spaces to shift the programs shown by the program IDs forward in the horizontal direction (e.g. in a leftward direction) and display them.

As can be seen from the above description, the display control device according to this Embodiment 1 is constructed in such away as to include: the cell information storage part 1 for storing attribution information about a plurality of programs which construct an electronic program guide; the selection information acquiring part 2 for acquiring a program ID showing a program currently being selected from among the plurality of programs; the cell searching part 3 for referring to the attribution information stored in the cell information storage part 1 to search through the plurality of programs for programs each having the same attribute as the program currently being selected shown by the program ID acquired by the selection information acquiring part 2; and the reallocation processing part 4 for outputting a command for deleting the programs other than the program currently being selected shown by the program ID acquired by the selection information acquiring part 2 and one or more programs found by the cell searching part 3 from among the plurality of programs, and removing the spaces caused by the deletion to shift the program currently being selected and the one or more programs found by the cell searching part 3 forward in a vertical direction or in a horizontal direction and display them to the display processing part 5, there is provided an advantage of enabling the user to intuitively grasp the channel, the program length, and so on of each of the one or more programs found by the cell searching part 3. More specifically, because when removing the spaces caused by the deletion to shift the one or more programs found by the cell searching part 3 forward in a vertical direction or in a horizontal direction and display them, the display control device moves the one or more programs found in the vertical direction or in the horizontal direction and display them (in the example of FIG. 4, moves the one or more programs in the vertical direction while preventing each of the one or more programs from extending off the column of the same channel) without changing the size of the box of each of the one or more programs, there is provided an advantage of enabling the user to intuitively grasp the channel, the program length, and so on of each of the one or more programs found by the cell searching part 3.

### Embodiment 2

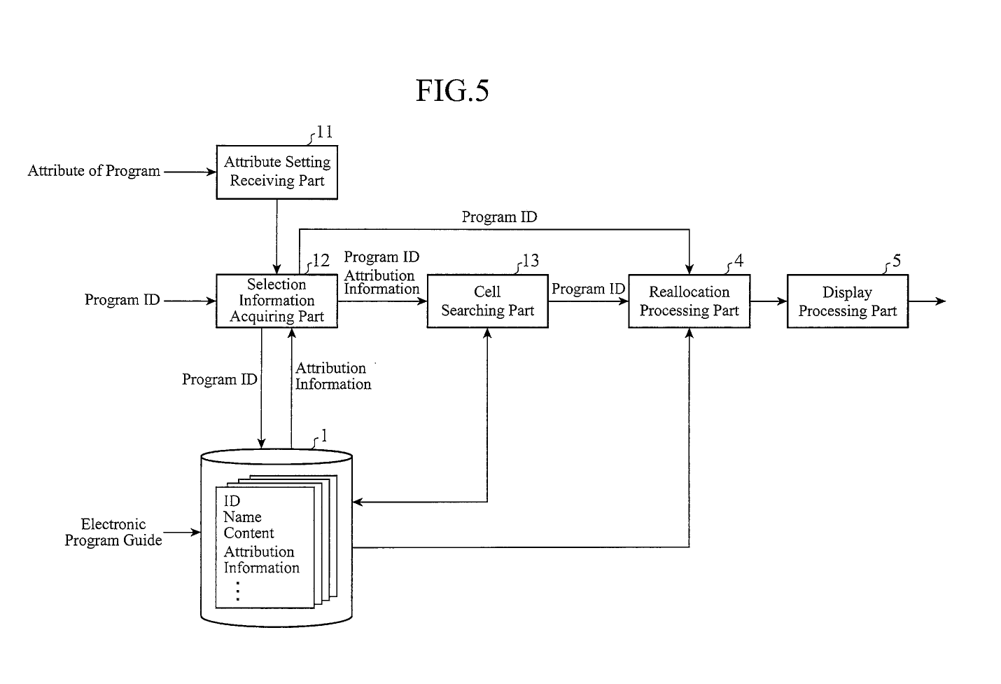

FIG. 5 is a block diagram showing a display control device according to Embodiment 2 of the present invention. In the figure, because the same reference numerals as those shown in FIG. 1 denote the same components or like components, the explanation of the components will be omitted hereafter. An attribute setting receiving part 11 consists of interface equipment (e.g., an infrared ray interface circuit or a LAN interface circuit) for acquiring information from, for example, a remote control, AV equipment, or the like, a semiconductor integrated circuit in which a CPU is mounted, and so on. The attribute setting receiving part carries out a process of receiving setting of an attribute for programs which are search targets according to the information acquired thereby. The attribute setting receiving part 11 constructs an attribute setting receiving unit.

A selection information acquiring part 12 consists of interface equipment (e.g., an infrared ray interface circuit or a LAN interface circuit) for acquiring information from, for example, the remote control, the AV equipment, or the like, a semiconductor integrated circuit in which a CPU is mounted, and so on. The selection information acquiring part carries out a process of acquiring a program ID showing a program currently being selected from among a plurality of programs which construct an electronic program guide from the remote control, the AV equipment, or the like, and also acquiring the attribution information of a program having the program ID from a cell information storage part 1 and then outputting the attribution information to a cell searching part 13, like the selection information acquiring part 2 shown in FIG. 1. The selection information acquiring part 12 also carries out a process of, when the attribute setting receiving part 11 receives setting of an attribute for programs which are search targets, notifying the attribute to the cell searching part 13. The selection information acquiring part 12 constructs a selection information acquiring unit and the attribute setting receiving unit.

The cell searching part 13 consists of, for example, an integrated circuit in which a CPU is mounted, or a one chip microcomputer. The cell searching part 13 carries out a process of comparing the attribution information outputted thereto from the selection information acquiring part 12 with attribution information included in cell information stored in the cell information storage part 1, searching through the plurality of programs which construct the electronic program guide for programs each having the same attribute as the program currently being selected, and outputting a program ID showing the program currently being selected and a program ID showing the program having the same attribute as the program currently being selected to a reallocation processing part 4, like the cell searching part 3 shown in FIG. 1. The cell searching part 13 also carries out a process of, when receiving the notification of the attribute set for programs which are search targets from the selection information acquiring part 12, referring to the attribution information included in the cell information stored in the cell information storage part 1 to search for programs each having the attribute notified thereto. The cell searching part 13 constructs a cell searching unit.

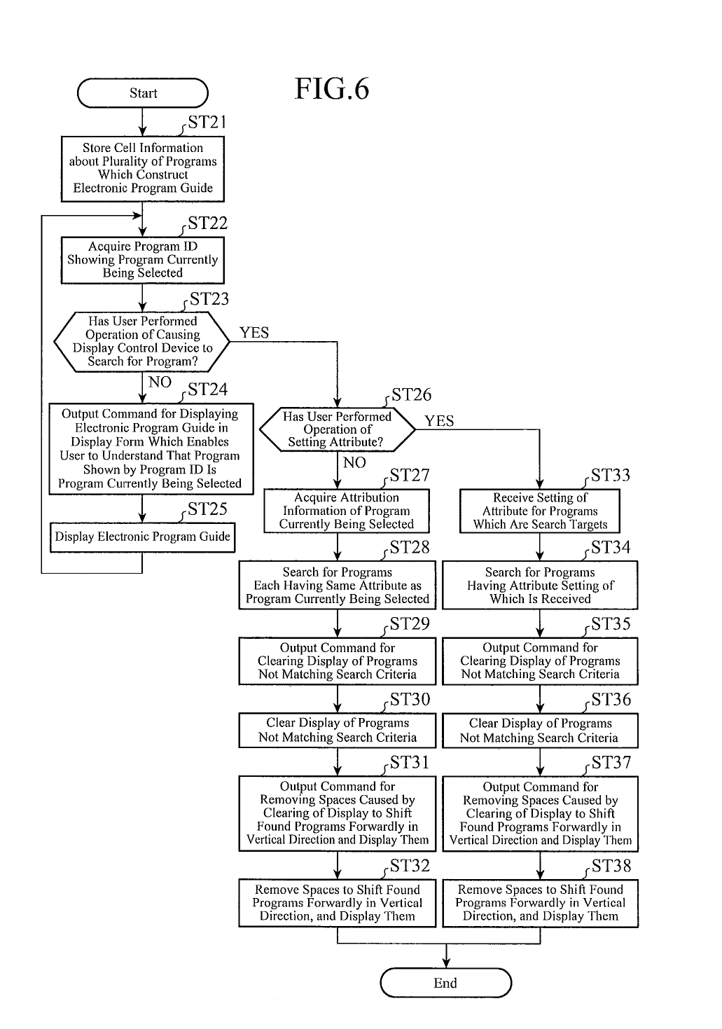

Although it is assumed in the example of FIG. 5 that the cell information storage part 1, the attribute setting receiving part 11, the selection information acquiring part 12, the cell searching part 13, the reallocation processing part 4, and a display processing part 5, which are the components of the display control device, consists of pieces of hardware for exclusive use, respectively, the display control device can consist of a computer. In the case in which the display control device consists of a computer, the cell information storage part 1 can be formed in a memory of the computer while a display control program in which the processes carried out by the attribute setting receiving part 11, the selection information acquiring part 12, the cell searching part 13, the reallocation processing part 4, and the display processing part 5 are described can be stored in the memory of the computer, a CPU of the computer can be made to execute the display control program stored in the memory, for example. FIG. 6 is a flow chart showing processing (display control method) carried out by the display control device according to Embodiment 2 of the present invention.

Next, the operation of the device will be explained. First, a TV electronic program guide received by the AV equipment, such as a television, is sent to the cell information storage part 1, and cell information which is information about a plurality of programs which construct the electronic program guide is stored in the cell information storage part 1, like in the case of above-mentioned Embodiment 1 (step ST21 of FIG. 6).

The selection information acquiring part 12 acquires a program ID showing a program currently being selected from among the plurality of programs which construct the electronic program guide from, for example, the remote control, the AV equipment, or the like (step ST22). When the user has not performed an operation of causing the display control device to search for programs (step ST23), the selection information acquiring part 12 outputs the program ID to the reallocation processing part 4.

When the user has not performed an operation of causing the display control device to search for programs, in response to the program ID from the selection information acquiring part 12, the reallocation processing part 4 acquires the electronic program guide from the cell information storage part 1, and outputs a command for displaying the electronic program guide in a display form which enables the user to understand that the program shown by the program ID is the program currently being selected to the display processing part 5, like that according to above-mentioned Embodiment 1 (step ST24). When receiving the command for displaying the electronic program guide from the reallocation processing part 4, the display processing part 5 displays the electronic program guide on a not-shown display, as shown in FIG. 4(a) (step ST25).

When the user performs an operation of causing the display control device to search for programs while the electronic program guide is displayed, the display control device carries out a process of searching for programs each having the same attribute as the program currently being selected, like that according to above-mentioned Embodiment 1. When the user further performs an operation of setting an attribute for programs which are search targets, the display control device carries out a search process of searching for programs each having the attribute set by the user.

When the user has not performed an operation of setting an attribute for programs which are search targets (step ST26), while the user has performed an operation of causing the display control device to search for programs (step ST23), the selection information acquiring part 12 acquires the attribution information of a program having the program ID showing the program currently being selected from the cell information storage part 1, and outputs the attribution information of the program currently being selected and the above-mentioned program ID to the cell searching part 13, like the selection information acquiring part 2 shown in FIG. 1 (step ST27). FIG. 4(b) shows an example in which the user performs an operation of pushing down a button “Search for programs belonging to the same genre” as the operation of causing the display control device to search for programs.

When receiving the attribution information and the program ID from the selection information acquiring part 12, the cell searching part 13 compares the attribution information with the attribution information included in the cell information stored in the cell information storage part 1, and searches through the plurality of programs which construct the electronic program guide for programs each having the same attribute as the program currently being selected, like the cell searching part 3 shown in FIG. 1 (step ST28). When finding a program having the same attribute as the program currently being selected, the cell searching part 13 outputs the program ID showing the program currently being selected, and the program ID showing the program having the same attribute as the program currently being selected to the reallocation processing part 4, like the cell searching part 3 shown in FIG. 1. However, when there exists no program having the same attribute as the program currently being selected, the cell searching part 13 outputs only the program ID showing the program currently being selected to the reallocation processing part 4.

When receiving the program IDs (the program ID showing the program currently being selected and the program ID showing the program having the same attribute as the program currently being selected) from the cell searching part 13, the reallocation processing part 4 outputs a command for clearing the display of the programs other than the programs shown by those program IDs (the programs whose genres are other than drama when searching for programs whose genre is drama) to the display processing part 5, like that according to above-mentioned Embodiment 1 (step ST29). When receiving the command for clearing the display of the programs other than the programs shown by those program IDs from the reallocation processing part 4, the display processing part 5 clears the display of the programs other than the program shown by those program IDs, like that according to above-mentioned Embodiment 1 (step ST30). For example, when searching for programs whose genre is drama, the display processing part clears the display of the programs other than the programs whose genre is drama, as shown in the FIG. 4(c).

When the display processing part 5 clears the display of the programs other than the programs shown by those program IDs, the reallocation processing part 4 outputs a command for removing the spaces caused by the clearing of the display to shift the programs shown by those program IDs forward in a vertical direction and display them to the display processing part 5, like that according to above-mentioned Embodiment 1 (step ST31). When receiving the command for removing the spaces caused by the clearing of the display to shift the programs shown by those program IDs forward in a vertical direction and display them from the reallocation processing part 4, the display processing part 5 removes the spaces to shift the programs shown by those program IDs forward in the vertical direction and display them, as shown in FIG. 4(d) (step ST32). At this time, a switch to each of the programs shown by those program IDs is carried out seamlessly by using an animation.

When the user performs an operation of setting an attribute for programs which are search targets (step ST26), while the user performs an operation of causing the display control device to search for programs (step ST23), the attribute setting receiving part 11 acquires the attribution information showing the attribute set for programs which are search targets from, for example, the remote control, AV equipment, or the like, and receives the setting of the attribute for programs which are search targets according to the attribution information and outputs the program attribute to the cell searching part 13 (step ST33).

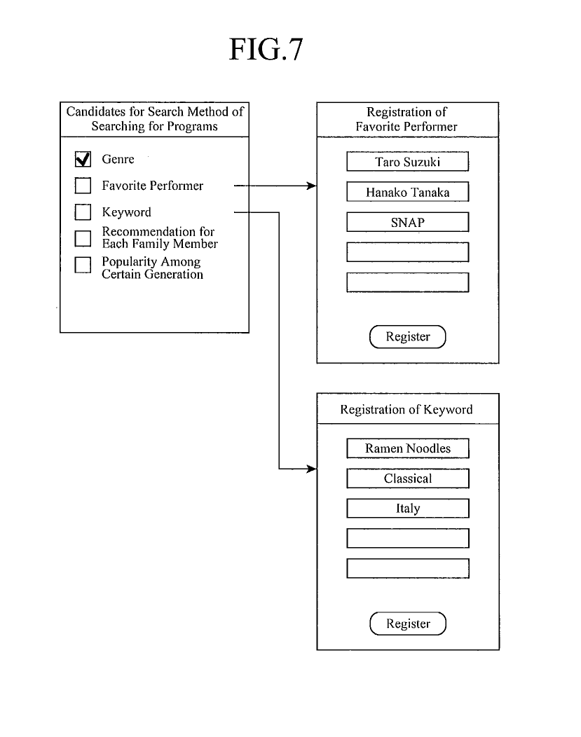

FIG. 7 is an explanatory drawing showing candidates for a search method of searching for programs. In the example of FIG. 7, in addition to program genre, favorite performer, keyword, recommendation for each family member, popularity among a certain generation (e.g. popularity among the twenty-something generation), and so on are prepared as the candidates for the search method. For example, when the user checks a checkbox “genre”, the display control device selects “Search by genre” as the search method of searching for programs. For example, when the user selects his or her desired genre (e.g. sport) on a screen not shown in the figure, the display control device sets the desired genre as the attribute. As a result, the display control device can search through the plurality of programs which construct the electronic program guide for programs belonging to the desired genre.

Further, when the user checks a checkbox “favorite performer”, the display control device selects “Search by performer” as the search method of searching for programs. In the example of FIG. 7, “Taro Suzuki”, “Hanako Tanaka”, and “SNAP” are registered as favorite performers. In this case, the display control device sets “favorite performer” as the attribute, and can search through the plurality of programs which construct the electronic program guide for programs in each of which one of the “favorite performers” appears.

Further, when the user checks a checkbox “keyword”, the display control device selects “Search by keyword” as the search method of searching for programs. In the example of FIG. 7, “ramen noodles”, “classical”, and “Italy” are registered as keywords. In this case, the display control device sets “keyword” as the attribute, and can search through the plurality of programs which construct the electronic program guide for programs each associated with one of the “keywords.”

When receiving the notification of the attribute of a program which is a search target from the selection information acquiring part 12, the cell searching part 13 refers to the attribution information included in the cell information stored in the cell information storage part 1, and searches for programs having the attribute notified thereto (step ST34). For example, when the checkbox “keyword” is checked, and “classical” is registered as a keyword, the cell searching part searches for programs associated with “classical.” When finding a program having the attribute notified thereto, the cell searching part 13 outputs a program ID showing the program to the reallocation processing part 4. In contrast, when there exists no program having the attribute notified thereto, the cell searching part 13 does not output any program ID to the reallocation processing part 4.

When receiving one or more program IDs (program IDs each showing a program having the attribute the setting of which is received by the attribute setting receiving part 11) from the cell searching part 13, the reallocation processing part 4 outputs a command for clearing the display of programs other than the programs shown by those program IDs to the display processing part 5 (step ST35). When receiving the command for clearing the display of the programs other than the programs shown by those program IDs from the reallocation processing part 4, the display processing part 5 clears the display of the programs other than the program shown by those program IDs (step ST36).

When the display processing part 5 clears the display of the programs other than the programs shown by those program IDs, the reallocation processing part 4 outputs a command for removing the spaces caused by the clearing of the display to shift the programs shown by those program IDs forward in a vertical direction and display them to the display processing part 5 (step ST37). When receiving the command for removing the spaces caused by the clearing of the display to shift the programs shown by those program IDs forward in a vertical direction and display them from the reallocation processing part 4, the display processing part 5 removes the spaces to shift the programs shown by those program IDs forward in the vertical direction and display them (step ST38). At this time, a switch to each of the programs shown by those program IDs is carried out seamlessly by using an animation.

In the above-mentioned example of the electronic program guide, because programs provided by different broadcast stations are aligned in a horizontal direction while programs provided by each broadcast station are aligned in a vertical direction in the order of broadcast time zones, the display processing part removes the spaces to shift the programs shown by the program IDs forward in the vertical direction (in an upward direction) and display them. In contrast, in a case in which programs provided by different broadcast stations are aligned in a vertical direction in the electronic program guide while programs provided by each broadcast station are aligned in a horizontal direction in the order of broadcast time zones, the display processing part can remove the spaces to shift the programs shown by the program IDs forward in the horizontal direction (e.g. in a leftward direction) and display them.

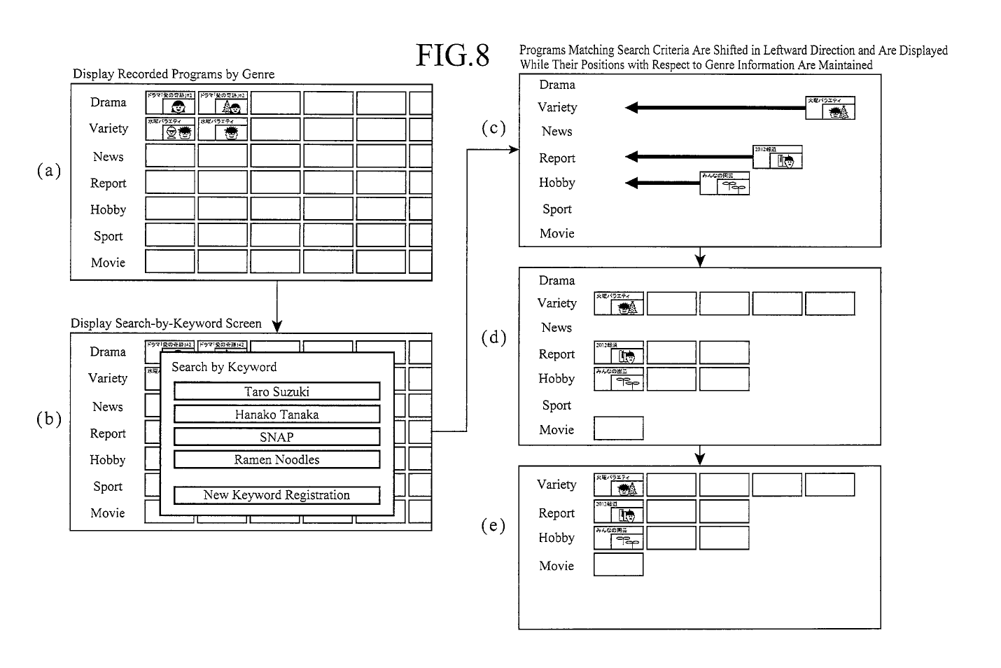

Although in this Embodiment 2 the example in which the display control device searches through the plurality of programs which construct the electronic program guide for programs each having the attribute the setting of which is received by the attribute setting receiving part 11 is shown, the display control device can alternatively search through a list of recorded programs as shown in FIG. 8 for programs each having the attribute the setting of which is received by the attribute setting receiving part 11. The cell information of each of the recorded programs is stored in the cell information storage part 1, and, when the user carries out an operation of commanding the display control device to display the recorded programs, the display processing part 5 can display the list of recorded programs as shown in FIG. 8(a) according to a command from the reallocation processing part 4.

In an example of FIG. 8(a), the recorded programs are displayed by genre. FIG. 8(b) shows an example in which when the user selects “Search by keyword” as the search method of searching for programs, the display control device displays a search-by-keyword screen which receives a selection of a desired keyword as the attribute set for programs which are search targets. Although in FIG. 8(b) the example in which when the user selects “Search by keyword” as the search method of searching for programs is shown, the search method of searching for programs is not limited to “Search by keyword.” It is needless to say that the search method of searching for programs can be, for example, “Search by genre” or “Search by performer.”

FIG. 8(c) shows an example in which recorded programs associated the keyword which is selected on the search-by-keyword screen shown in FIG. 8(b) have been found by the cell searching part 13, and the display of the recorded programs other than the recorded programs found by the cell searching part is cleared. FIG. 8(d) shows an example in which the spaces caused by the clearing of the display are removed and the recorded programs found by the cell searching part 13 are shifted forward in a leftward direction and are displayed (the recorded programs are moved seamlessly while their positions with respect to the genre information are maintained). FIG. 8(e) shows an example in which because no news programs and no sport programs have been found, the rows for the display of news programs and sport programs are deleted, and the spaces caused by this deletion are removed and the report programs, the hobby programs, and the movie programs are moved in an upward direction and are displayed.

As can be seen from the above description, because the display control device according to this Embodiment 2 is constructed in such a way as to includes: the cell information storage part 1 for storing attribution information about a plurality of programs which construct an electronic program guide; the attribute setting receiving part 11 for receiving setting of the attribute for programs which are search targets; the cell searching part 13 for referring to attribution information stored in the cell information storage part 1, and for searching through the plurality of programs for programs each having the attribute the setting of which is received by the attribute setting receiving part 11; and the reallocation processing part 4 for outputting a command for deleting the programs other than one or more programs found by the cell searching part 13 from among the plurality of programs, and removing the spaces caused by the deletion to shift the one or more programs found by the cell searching part 13 forward in a vertical direction or in a horizontal direction and display them to the display processing part 5, there is provided an advantage of enabling the user to intuitively grasp the channel, the program length, and so on of each of the one or more programs found by the cell searching part 13. More specifically, because when removing the spaces caused by the deletion to shift the one or more programs found by the cell searching part 13 forward in a vertical direction or in a horizontal direction and display them, the display control device moves the one or more programs found in the vertical direction or in the horizontal direction and display them (in the example of FIG. 8, moves the one or more programs in the horizontal direction while preventing each of the one or more programs from extending off the row of the same genre) without changing the size of the box of each of the one or more programs, there is provided an advantage of enabling the user to intuitively grasp the channel, the program length, and so on of each of the one or more programs found by the cell searching part 13.

### Embodiment 3

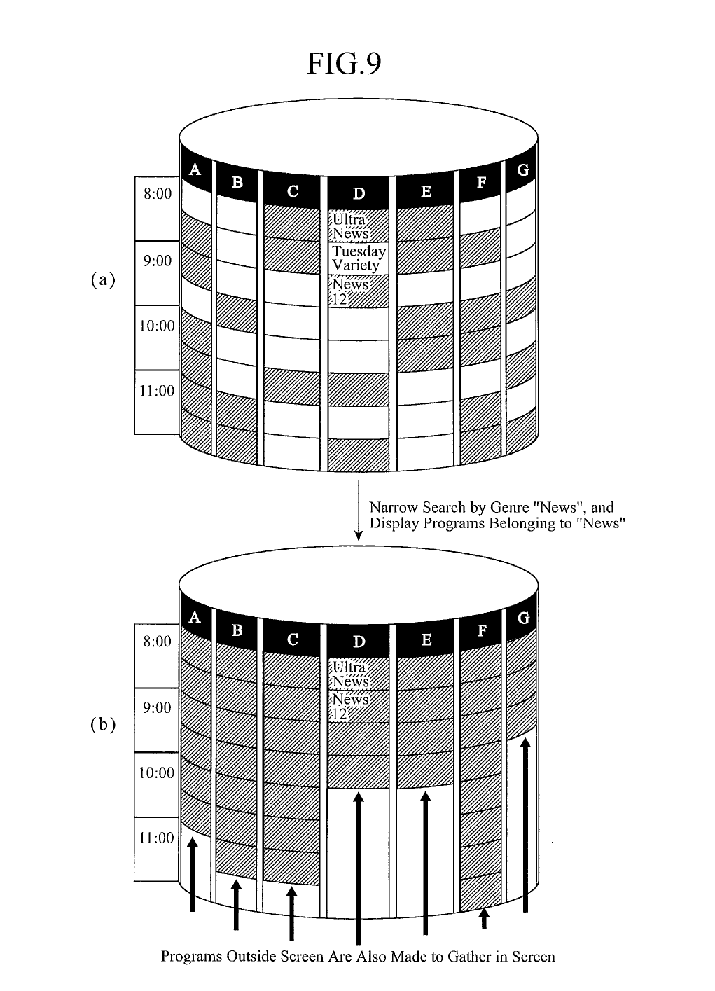

Although in above-mentioned Embodiments 1 and 2 the examples in which the display control device displays an electronic program guide in the form of a plane, the display control device can alternatively place a plurality of programs which construct the electronic program guide on a cylindrical side surface to display them, as shown in FIG. 9. Also in this case, the display control device can remove the spaces caused by clearing of the display of programs other than one or more programs found by the cell searching part 3 or 13 to shift the one or more programs found by the cell searching part 3 or 13 forward in a vertical direction (in an upward direction) and display them, also programs existing outside the displayed screen are made to gather in the screen. As a result, when, for example, the electronic program guide has program data about a week's worth of programs, programs matching the search criteria are found from the program data about a week's worth of programs, and are made to move to within and gather in the screen. However, when many programs are found, there are some programs that are not moved to within the screen.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

What is claimed is:

1. A display control device comprising:
a cell attribute information storage unit for storing attribution information about a plurality of cells which construct a table to be drawn;
a selection information acquiring unit for acquiring selection information showing a cell currently being selected from among said plurality of cells;
a cell searching unit for referring to the attribution information stored in said cell attribute information storage unit to search through said plurality of cells for cells each having a same attribute as the cell currently being selected shown by the selection information acquired by said selection information acquiring unit; and
a cell display unit for deleting cells other than the cell currently being selected shown by the selection information acquired by said selection information acquiring unit and one or more cells found by said cell searching unit from said plurality of cells, and for shifting the cell currently being selected and the one or more cells found by said cell searching unit forward in a vertical direction or in a horizontal direction to display these cells.

2. The display control device according to claim 1, wherein in a state in which the cell display unit displays the plurality of cells which construct the table to be drawn, after clearing a display of the cells other than the cell currently being selected shown by the selection information acquired by the selection information acquiring unit and the one or more cells found by the cell searching unit, the cell display unit moves a position where the cell currently being selected is displayed and a position where the one or more cells found by said cell searching unit is displayed in the vertical direction or in the horizontal direction.

3. A display control device comprising:
a cell attribute information storage unit for storing attribution information about a plurality of cells which construct a table to be drawn;
an attribute setting receiving unit for receiving setting of an attribute for cells which are search targets;
a cell searching unit for referring to the attribution information stored in said cell attribute information storage unit to search through said plurality of cells for cells each having the attribute the setting of which is received by said attribute setting receiving unit; and
a cell display unit for deleting cells other than one or more cells found by said cell searching unit from said plurality of cells, and for shifting the one or more cells found by said cell searching unit forward in a vertical direction or in a horizontal direction to display the one or more cells.

4. The display control device according to claim 3, wherein in a state in which the cell display unit displays the plurality of cells which construct the table to be drawn, after clearing a display of the cells other than the one or more cells found by the cell searching unit, the cell display unit moves a position where the one or more cells found by said cell searching unit is displayed in the vertical direction or in the horizontal direction.

5. A display control method comprising:
a cell attribute information memory processing step of a cell attribute information storage unit storing attribution information about a plurality of cells which construct a table to be drawn;
a selection information acquisition processing step of a selection information acquiring unit acquiring selection information showing a cell currently being selected from among said plurality of cells;
a cell search processing step of a cell searching unit referring to the attribution information stored in said cell attribute information memory processing step to search through said plurality of cells for cells each having a same attribute as the cell currently being selected shown by the selection information acquired in said selection information acquisition processing step; and
a cell display processing step of a cell display unit deleting cells other than the cell currently being selected shown by the selection information acquired in said selection information acquisition processing step and one or more cells found in said cell search processing step from said plurality of cells, and shifting the cell currently being selected and the one or more cells found in said cell search processing step forward in a vertical direction or in a horizontal direction to display these cells.
